(19) United States
(12) Patent Application Publication
(10) Pub. No.: US 2018/0082331 A1
(43) Pub. Date: Mar. 22, 2018

(54) PREDICTING A USER QUALITY RATING FOR A CONTENT ITEM ELIGIBLE TO BE PRESENTED TO A VIEWING USER OF AN ONLINE SYSTEM

(71) Applicant: Facebook, Inc., Menlo Park, CA (US)

(72) Inventors: Matthew Feldman, San Francisco, CA (US); Shuo Li, Mountain View, CA (US); Cassidy Jake Morris, San Francisco, CA (US); Jonathan Mooser, Mountain View, CA (US); Xu Wang, Mountain View, CA (US)

(21) Appl. No.: 15/272,764

(22) Filed: Sep. 22, 2016

(51) Int. Cl. G06Q 30/02

(52) U.S. Cl. CPC G06Q 30/0255; G06Q 30/0269; G06Q 30/0273

(57) ABSTRACT

An online system selects content items for presentation to viewing users of the online system based on a composite score associated with each content item that includes a quality component and a revenue component. The revenue component is based on a monetary amount an advertiser associated with the content item is willing to pay for each interaction with the content item by a prospective viewing user, while the quality component indicates the quality of the content item to the prospective viewing user. The quality component is predicted based on explicit user quality ratings received from viewing users for various content items previously presented to the viewing users, in which the viewing users have at least a threshold measure of similarity to the prospective viewing user and/or the various content items rated by the viewing users have at least a threshold measure of similarity to the content item being scored.

### BACKGROUND

This disclosure relates generally to online systems, and more specifically to predicting a user quality rating for a content item that is incorporated into a score used to select content for presentation to users of an online system.

An online system allows its users to connect and communicate with other online system users. Users create profiles on the online system that are tied to their identities and include information about the users, such as interests and demographic information. The users may be individuals or entities such as corporations or charities. Because of the popularity of online systems and the significant amount of user-specific information maintained by online systems, an online system provides an ideal forum for allowing users to share content by creating content items for presentation to additional online system users. For example, users may share photos or videos they have uploaded by creating content items that include the photos or videos that are presented to additional users to which they are connected on the online system. An online system also provides advertisers with abundant opportunities to increase awareness about their products or services by presenting advertisements to online system users. For example, advertisements presented to users allow an advertiser to gain public attention for products or services and to persuade online system users to take an action regarding the advertiser's products, services, opinions, or causes.

Conventionally, online systems generate revenue by displaying content to their users. For example, an online system may charge advertisers for each presentation of an advertisement to an online system user (i.e., each “impression”), or for each interaction with an advertisement by an online system user (e.g., each click on the advertisement, each purchase made as a result of clicking through the advertisement, etc.). By presenting high quality advertisements, online systems may increase the likelihood that users will interact with the advertisements. For example, if a user scrolls through a newsfeed and views a visually appealing advertisement that includes a strong call-to-action, the advertisement is much more likely to capture the user's interest and result in a conversion than advertisements that are not as engaging. Moreover, high quality advertisements that engage users are more likely to increase user retention on online systems.

To improve user retention rates and maximize long-term revenue, online systems may select content items that are both high quality and associated with a high bid amount for presentation to users. Since users are more likely to interact with high quality content items than they are with low quality content items, the quality of a content item may be determined based on a predicted likelihood that the user will perform an interaction with the content item. Online systems may predict the likelihood that a particular user will perform an interaction with a content item based on historical interactions by additional users with the same or similar content items, in which the additional users have at least a threshold measure of similarity to the particular user. For example, if a high percentage of users of an online system that were presented with a content item and subsequently clicked on the content item are of the same age group and gender as a particular user, the online system may predict that the particular user is likely to click on the content item as well.

However, historical interactions by users with content items may not be reliable indicators of the quality of the content items. For example, clickbait advertisements (i.e., advertisements with which users are likely to interact due to attractive, but misleading content) may appear to be high quality advertisements based on their generally high click-through rates, but are in fact low quality advertisements. Users who interact with clickbait advertisements may feel cheated out of receiving the content they were hoping to receive when they interacted with the advertisements. By failing to obtain explicit user ratings about the quality of content items, online systems may inadvertently present low quality content to users, which may discourage user engagement with the online systems, thus decreasing the number of opportunities the online systems have to generate revenue.

### SUMMARY

An online system uses a content selection process to select content items (e.g., advertisements) for presentation to viewing users of the online system based on a composite score associated with each content item that includes a quality component (“quality score”) as well as a revenue component (“revenue score”). For example, the online system ranks multiple content items based on their associated composite scores and selects one or more content items for presentation to a viewing user based on the ranking. In some embodiments, the composite score is expressed as a bid amount used in the content selection process (e.g., an advertisement auction). The composite score associated with the content item may be determined in various ways. For example, the composite score associated with a content item may be determined as a sum of its associated quality score and its associated revenue score or as an average of the scores. In some embodiments, each of the scores may contribute unequally to the composite score (e.g., the scores may be weighted differently).

The revenue component of a composite score associated with a content item is based on a monetary amount an advertiser associated with the content item is willing to pay in exchange for presenting the content item to a viewing user of the online system (i.e., each “impression” of the content item) and/or an amount the advertiser is willing to pay in exchange for each interaction with the content item by the viewing user (e.g., each click on the content item, each comment on the content item, etc.). In some embodiments, the revenue score may be specific to a particular viewing user. For example, the revenue score associated with an advertisement is based on a monetary bid amount provided by an advertiser that indicates an amount the advertiser is willing to pay in exchange for presentation of the advertisement to a viewing user, in which the amount varies based on the number of times the advertisement was previously presented to the user.

The quality component of a composite score associated with a content item is specific to a viewing user of the online system, such that the quality score is indicative of the quality of the content item to the viewing user. For example, the quality score associated with an advertisement indicates a likelihood that a viewing user will have an interest in the advertisement and will therefore perform an action associated with the advertisement (e.g., click on the advertisement, make a purchase as a result of being presented with the advertisement, etc.). The online system determines the quality score associated with a content item by predicting a “user quality rating” associated with the content item that indicates the quality of the content item to a prospective viewing user of the online system to whom the content item may be presented. For example, the user quality rating associated with an advertisement may be a numerical value selected from a range of one to five, in which a user quality rating of five indicates the prospective viewing user's predicted user quality rating for the advertisement is very high (i.e., the prospective viewing user will likely rate the advertisement a high-quality content item).

The online system may predict the user quality rating associated with the content item for the prospective viewing user using a machine-learned model. The machine-learned model may be trained using explicit user quality ratings received from viewing users of the online system for various content items previously presented to the viewing users (e.g., results of surveys administered to individual viewing users or opinions of multiple viewing users obtained via crowdsourced data). For example, the online system administers surveys that allow viewing users to rate content items based on their quality using a numerical value or to assess the relative quality of content items in a side-by-side comparison (e.g., using bakeoff testing). The training data also may include explicit quality ratings received from professional content item raters. The individual ratings received from viewing users and/or professional content item raters may be included in a set of training data that is used to train the machine-learned model. For example, each individual rating received from viewing users and professional content item raters constitutes an instance in the training data that is used to train the machine-learned model. In one embodiment, multiple individual ratings may be compiled into a single instance included in a set of training data that is used to train the machine-learned model. For example, individual ratings collected over the course of a day or received from users associated with a particular demographic group are averaged; this average rating is then used to train the machine-learned model.

In embodiments in which a machine-learned model is trained using explicit user quality ratings received from viewing users of the online system, the viewing users from whom the user quality ratings were received may have at least a threshold measure of similarity to the prospective viewing user and/or the various content items rated by the viewing users may have at least a threshold measure of similarity to the content item. For example, the machine-learned model predicts the prospective viewing user's quality rating for a content item based on user quality ratings received from viewing users surveyed about the content item, in which the viewing users are associated with user attributes (e.g., demographic information) having at least a threshold measure of similarity to user attributes associated with the prospective viewing user. As an additional example, the machine-learned model predicts the prospective viewing user's quality rating for a content item based on crowdsourced user quality ratings received from viewing users for content items associated with particular content item features (e.g., images, metadata, etc.) having at least a threshold measure of similarity to content item features associated with the content item. The machine-learned model may be updated by the online system, (e.g., periodically or as new training data becomes available).

In some embodiments, the machine-learned model may associate different weights with the user quality ratings received from viewing users of the online system for different content items based on user attributes (e.g., age, gender, geographic location, actions performed by the users on the online system, etc.) associated with the viewing users. For example, the machine-learned model may predict the user quality rating associated with the content item for the prospective viewing user by weighting user quality ratings received from viewing users who have more user attributes in common with the prospective viewing user more heavily than user quality ratings received from viewing users who have fewer user attributes in common with the prospective viewing user. As an additional example, since purchasing a product after clicking though an advertisement for the product is a reliable indicator of the quality of the advertisement, the machine-learned model may associate a greater weight with user quality ratings received from viewing users who are more likely to make a purchase in conjunction with clicking on a content item than with user quality ratings received from viewing users who frequently click on advertisements, but do not make a subsequent purchase.

The machine-learned model also may associate different weights with the user quality ratings received from viewing users of the online system based on content item features or categories associated with the content items rated by the viewing users. For example, the machine-learned model may predict the user quality rating associated with an advertisement for a car for the prospective viewing user by weighting user quality ratings received from viewing users of the online system associated with the same advertisement more heavily than the viewing users' user quality ratings associated with advertisements for cars in general. In this example, both the viewing users' user quality ratings associated with the same advertisement and with advertisements for cars in general are weighted more heavily than the viewing users' user quality ratings associated with advertisements for non-car products.

In addition to the explicit user quality ratings received from various viewing users of the online system associated with various content items, the quality score associated with the content item also may be based on the prospective viewing user's predicted likelihood of performing one or more types of interactions with the content item. For example, the online system determines the quality score associated with the content item based on a sum of the prospective viewing user's predicted user quality rating for the content item and predicted likelihoods that the prospective viewing user will perform various types of interactions with the content item (e.g., indicate a preference for the content item, click on the content item, share the content item, etc.). In some embodiments, the predicted likelihoods that the prospective viewing user will perform different types of interactions with the content item may be associated with different weights. For example, if a user that generated a content item has a goal of increasing the number of viewing users who share the content item by 20% and a goal of increasing the number of viewing users who comment on the content item by 5%, when determining the quality score associated with the content item, the online system may associate a greater weight with a probability that the prospective viewing user will share the content item than with a probability that the prospective viewing user will comment on the content item.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flow chart of a method for determining a composite score associated with a content item eligible to be presented to a viewing user of an online system, in accordance with an embodiment.

FIGS. 4A and 4B are examples of user quality ratings associated with one or more content items, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

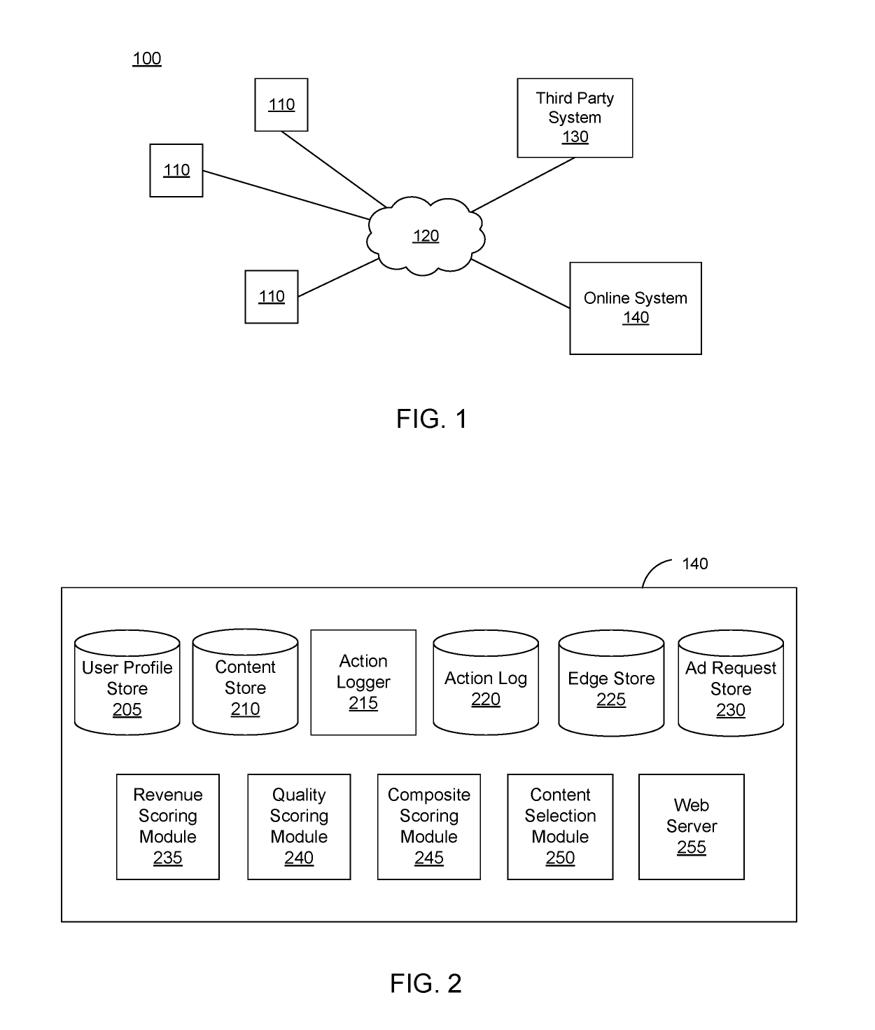

FIG. 1 is a block diagram of a system environment 100 for an online system 140. The system environment 100 shown by FIG. 1 comprises one or more client devices 110, a network 120, one or more third party systems 130, and the online system 140. In alternative configurations, different and/or additional components may be included in the system environment 100. The embodiments described herein may be adapted to online systems that are not social networking systems.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

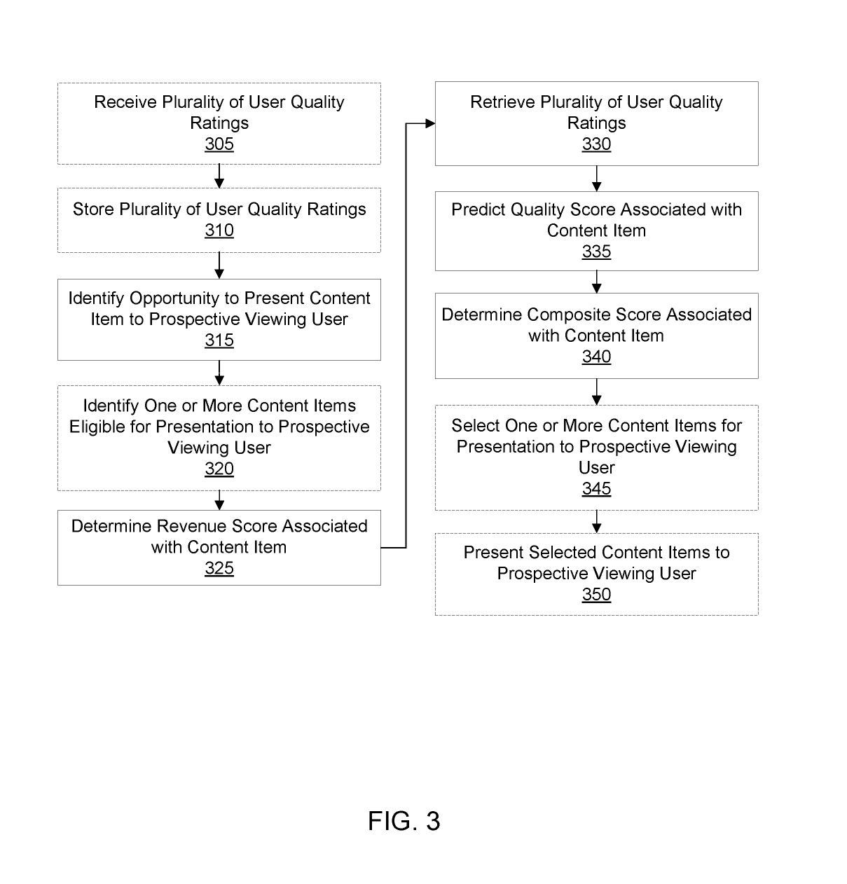

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device 110. In other embodiments, a third party system 130 provides content or other information for presentation via a client device 110. A third party system 130 also may communicate information to the online system 140, such as advertisements, content, or information about an application provided by the third party system 130.

FIG. 2 is a block diagram of an architecture of the online system 140. The online system 140 shown in FIG. 2 includes a user profile store 205, a content store 210, an action logger 215, an action log 220, an edge store 225, an ad request store 230, a revenue scoring module 235, a quality scoring module 240, a composite scoring module 245, a content selection module 250, and a web server 255. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and also may include profile information inferred by the online system 140. In one embodiment, a user profile includes multiple data fields, each describing one or more user attributes of the corresponding online system user. Examples of information stored in a user profile include biographic, demographic, and other types of descriptive information, such as work experience, educational history, gender, hobbies or preferences, locations and the like. A user profile also may store other information provided by the user, for example, images or videos. In certain embodiments, images of users may be tagged with information identifying the online system users displayed in an image. A user profile in the user profile store 205 also may maintain references to actions by the corresponding user performed on content items in the content store 210 and stored in the action log 220.

In some embodiments, the user profile store 205 stores explicit user quality ratings received from viewing users of the online system 140 for various content items previously presented to the viewing users. The explicit user quality ratings may be stored in association with the user profiles associated with the viewing users. For example, the result of a survey administered to a viewing user about the quality of a content item is stored in association with the viewing user's user profile and information describing the content item (e.g., contents of the content item, metadata associated with the content item, images included in the content item, and any other suitable content item features). A user quality rating for a content item received from a viewing user may be expressed as a score or other numerical value (e.g., a score selected from a range of one to five, in which a score of five indicates a content item of the highest quality). Alternatively, a user quality rating for a content item may be expressed as a relative rating. For example, multiple content items may be ranked based on their relative qualities or a preference for one content item over another may be expressed as a result of a comparison of two content items using bakeoff testing.

While user profiles in the user profile store 205 are frequently associated with individuals, allowing individuals to interact with each other via the online system 140, user profiles also may be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a page (e.g., brand page), an advertisement, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

In various embodiments, the content store 210 stores information describing content item features associated with content items. Examples of content item features associated with a content item include information describing a subject associated with the content item, a user associated with the content item (e.g., an advertiser), contents of the content item (e.g., images or text), tags or other types of metadata associated with the content item, a goal associated with the content item (e.g., receiving a click from a viewing user of the online system 140 presented with the content item), targeting criteria associated with the content item, a score or bid amount associated with the content item, etc. For example, content item features associated with a content item include information identifying a user that created the content item and tags associated with images included in the content item.

Explicit user quality ratings associated with content items also may be stored in the content store 210. For example, an explicit user quality rating received by the online system 140 as a response to a survey administered to a viewing user about the quality of a content item is stored as an entry in a table associated with the content item in the content store 210. In the previous example, the entry may include information describing the user quality rating (e.g., information describing or identifying the viewing user that provided the rating, the date and time the rating was received, etc.).

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the online system 140 to track user actions on the online system 140, as well as actions on the third party system 130 that communicate information to the online system 140. Users may interact with various objects on the online system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 also may store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 for storing in the action log 220 by the application for recordation and association with the user by the social networking system 140.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features also may represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate a user's interest in an object, a topic, or another user in the online system 140 based on actions performed by the user. Computation of affinity is further described in U.S. patent application Ser. No. 12/978,265, filed on Dec. 23, 2010 (U.S. Publication No. US 20120166532 A1, published on Jun. 28, 2012), U.S. patent application Ser. No. 13/690,254 (U.S. Publication No. U.S. Pat. No. 9,070,141 B2, published on Jun. 30, 2015), filed on Nov. 30, 2012, U.S. patent application Ser. No. 13/689,969, filed on Nov. 30, 2012 (U.S. Publication No. U.S. Pat. No. 9,317,812 B2, published on Apr. 19, 2016), and U.S. patent application Ser. No. 13/690,088, filed on Nov. 30, 2012 (U.S. Publication No. US 20140156360 A1, published on Jun. 5, 2014), each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement requests (“ad requests”) are included in the ad request store 230. An ad request includes advertisement content, also referred to as an “advertisement,” and a bid amount. The advertisement is text, image, audio, video, or any other suitable data presented to a user. In various embodiments, the advertisement also includes a landing page specifying a network address to which a user is directed when the advertisement content is accessed. The bid amount is associated with an ad request by an advertiser and is used to determine an expected value, such as monetary compensation, provided by the advertiser to the online system 140 if an advertisement in the ad request is presented to a user, if a user interacts with the advertisement in the ad request when presented to the user, or if any suitable condition is satisfied when the advertisement in the ad request is presented to a user. For example, the bid amount specifies a monetary amount that the online system 140 receives from the advertiser if an advertisement in an ad request is displayed. In some embodiments, the expected value to the online system 140 for presenting the advertisement may be determined by multiplying the bid amount by a probability of the advertisement being accessed by a user.

Additionally, an ad request may include one or more targeting criteria specified by the advertiser. Targeting criteria included in an ad request specify one or more user attributes of users eligible to be presented with advertisement content in the ad request. For example, targeting criteria are used to identify users associated with user profile information, edges, or actions satisfying at least one of the targeting criteria. Hence, targeting criteria allow an advertiser to identify users having specific user attributes, simplifying subsequent distribution of content to different users.

In one embodiment, targeting criteria may specify actions or types of connections between a user and another user or object of the online system 140. Targeting criteria also may specify interactions between a user and objects performed external to the online system 140, such as on a third party system 130. For example, targeting criteria identifies users who have performed a particular action, such as having sent a message to another user, having used an application, having joined or left a group, having joined an event, having generated an event description, having purchased or reviewed a product or service using an online marketplace, having requested information from a third party system 130, having installed an application, or having performed any other suitable action. Including actions in targeting criteria allows advertisers to further refine users eligible to be presented with advertisement content from an ad request. As another example, targeting criteria identifies users having a connection to another user or object or having a particular type of connection to another user or object. For example, targeting criteria in an ad request identifies users connected to an entity, where information stored in the connection indicates that the users are employees of the entity.

The revenue scoring module 235 may determine a revenue score associated with a content item. The revenue score associated with a content item may be based on a monetary amount an advertiser associated with the content item is willing to pay in exchange for presenting the content item to a viewing user of the online system 140 (i.e., each “impression” of the content item). The revenue score also or alternatively may be based on a monetary amount an advertiser associated with the content item is willing to pay in exchange for each interaction with the content item by the viewing user (e.g., each click on the content item, each time the content item is shared with an additional user of the online system 140, etc.). In some embodiments, the revenue score may be specific to a viewing user of the online system 140. For example, the revenue score associated with an advertisement is based on a monetary bid amount provided by an advertiser that indicates an amount the advertiser is willing to pay in exchange for presentation of the advertisement to a particular viewing user (e.g., a viewing user associated with a specific geographic location that frequently makes purchases after clicking through advertisements).

The quality scoring module 240 may predict a quality score associated with a content item that is specific to a viewing user of the online system 140 and indicates the quality of the content item to the viewing user. For example, the quality score associated with an advertisement indicates a likelihood that a viewing user will have an interest in the advertisement and will therefore perform an action associated with the advertisement (e.g., click on the advertisement, make a purchase as a result of being presented with the advertisement, etc.). The quality scoring module 240 may predict the quality score associated with a content item based on a predicted user quality rating associated with the content item for the viewing user. The user quality rating for a content item may be expressed as a score or other numerical value (e.g., a score selected from a range of one to five, in which a score of five indicates that the viewing user will likely rate the content item a high-quality content item and a score of one indicates that the viewing user will likely rate the content item a low-quality content item).

In some embodiments, the quality score associated with a content item also may be based on a viewing user's predicted likelihood of performing one or more types of interactions with the content item. For example, the quality scoring module 240 determines the quality score associated with a content item based on a sum of a viewing user's predicted user quality rating for the content item and predicted likelihoods that the viewing user will perform various types of interactions with the content item (e.g., indicate a preference for the content item, click on the content item, share the content item, etc.). In various embodiments, the likelihoods that a viewing user will perform different types of interactions with the content item may be associated with different weights. For example, if an advertiser has a goal of increasing the number of viewing users who make a purchase after clicking on an advertisement by 30% and a goal of increasing the number of viewing users who express a preference for the advertisement by 5%, when determining the quality score associated with the advertisement, the quality scoring module 240 may associate a greater weight with a probability that a viewing user will make a purchase after clicking on the advertisement than with a probability that the viewing user will express a preference for the advertisement.

In some embodiments, the quality scoring module 240 may predict the user quality rating associated with a content item for a viewing user using a machine-learned model. The machine-learned model may be trained using data that may be obtained from various sources. The training data may include crowdsourced data (e.g., explicit user quality ratings received from viewing users of the online system 140 that may be expressed as responses to surveys administered to individual viewing users of the online system 140 for various content items previously presented to the viewing users). For example, the online system 140 administers surveys that allow viewing users to rate content items based on their quality using a numerical scale or to assess the relative quality of content items in a side-by-side comparison using bakeoff testing. The training data also may include explicit quality ratings received from professional content item raters.

In one embodiment, each individual rating is used to train the machine-learned model. For example, each individual rating received from viewing users and professional content item raters is an instance in a set of training data that is used to train the machine-learned model. In another embodiment, multiple individual ratings may be compiled into a single instance included in a set of training data that is used to train the machine-learned model. For example, individual ratings collected over the course of a day or received from users associated with a particular demographic group are averaged; this average rating is then used to train the machine-learned model.

In various embodiments, the machine-learned model may predict the user quality rating associated with a content item for a viewing user based on explicit user quality ratings about the quality of various content items received from viewing users of the online system 140, in which the viewing users have at least a threshold measure of similarity to the viewing user. For example, the machine-learned model predicts the user quality rating associated with a content item for the viewing user based on results received from viewing users surveyed about the content item, in which the viewing users are associated with user attributes (e.g., demographic information) having at least a threshold measure of similarity to those associated with the viewing user. In this example, the machine-learned model may predict the user quality rating associated with the content item for the viewing user as an average of the user quality ratings received from the viewing users.

The machine-learned model also may predict the user quality rating associated with a content item for a viewing user based on explicit user quality ratings about the quality of various content items having at least a threshold measure of similarity to the content item. For example, the machine-learned model may predict the user quality rating associated with an advertisement for a mobile device based on explicit user quality ratings about the quality of the same advertisement or different advertisements for the mobile device that belong to the same advertising campaign. As an additional example, if a viewing user is a member of a photography group maintained by the online system 140, the machine-learned model may use crowdsourced user quality ratings received from viewing users who are also members of the group for content items associated with landscape photography to predict the viewing user's user quality rating for a content item that is also associated with landscape photography.

In some embodiments, the machine-learned model may associate different weights with user quality ratings associated with various content items received from viewing users of the online system 140 based on user attributes associated with the viewing users. For example, the machine-learned model may predict the user quality rating associated with a content item for a viewing user by weighting user quality ratings received from viewing users who have more user attributes (e.g., age group, click-through rate, etc.) in common with the viewing user more heavily than user quality ratings received from users who have fewer user attributes in common with the viewing user. As an additional example, since purchasing a product or subscribing to a service after clicking through an advertisement for the product or service is a reliable indicator of the quality of the advertisement, the machine-learned model may associate a greater weight with user quality ratings received from viewing users who purchase products or subscribe to services more often in conjunction with clicking on a content item than with user quality ratings received from viewing users who frequently click on advertisements, but do not subsequently make a purchase or subscribe to a service.

The machine-learned model also may associate different weights with the user quality ratings received from viewing users of the online system 140 based on content item features associated with the content items rated by the viewing users. For example, the machine-learned model may predict the user quality rating associated with an advertisement for auto insurance by a viewing user by weighting user quality ratings received from viewing users of the online system 140 associated with the same advertisement more heavily than the viewing users' user quality ratings associated with advertisements for auto insurance in general. In this example, both the viewing users' user quality ratings associated with the same advertisement and with advertisements for auto insurance in general are weighted more heavily than the viewing users' user quality ratings associated with advertisements for products other than auto insurance. The machine-learned model may be updated by the quality scoring module 240, (e.g., periodically or as new survey responses or other types of training data become available).

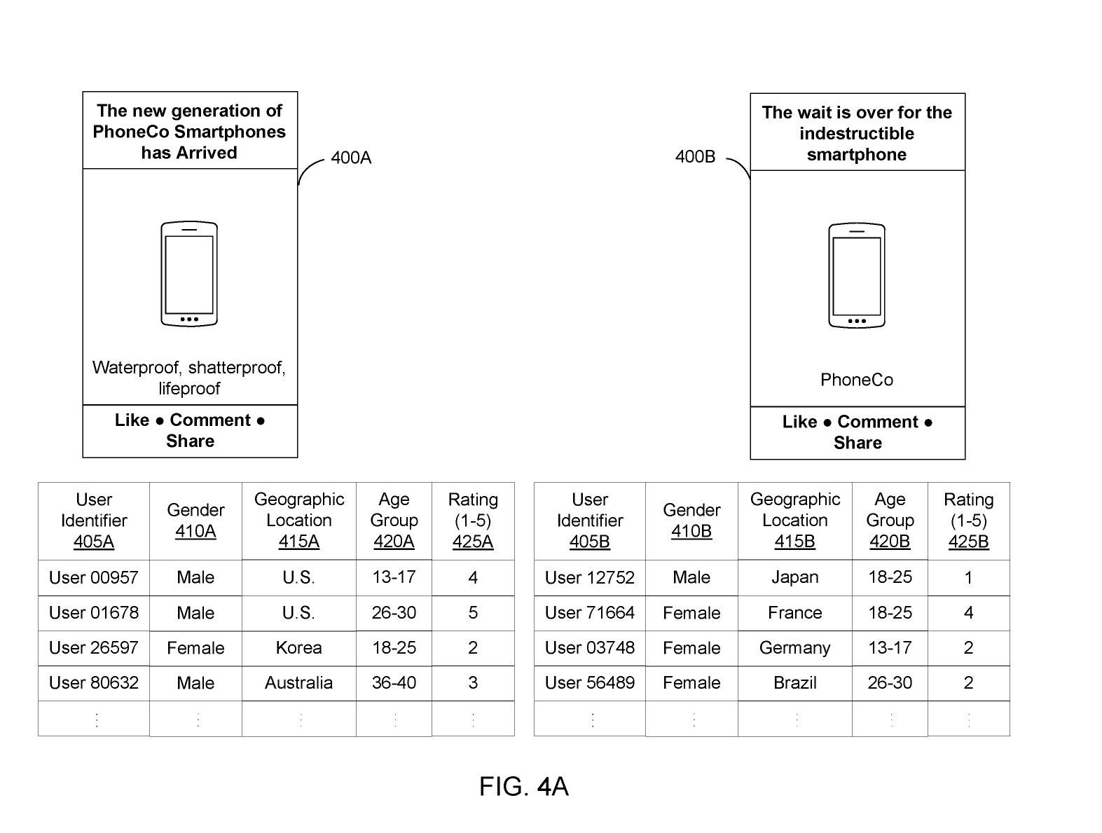

The composite scoring module 245 may determine a composite score associated with a content item based on both the quality score and the revenue score associated with the content item. For example, the composite score associated with an advertisement is determined as a sum of its quality score and its revenue score. In some embodiments, the quality score and the revenue score associated with a content item may contribute unequally to the composite score associated with the content item. For example, the composite scoring module 245 may associate different weights with the quality score and the revenue score and determine the composite score based on the weights. In some embodiments, the composite score is expressed as a bid amount used in a content selection process. For example, if the content item is an advertisement, the composite score may be expressed as a bid amount that is used in an advertisement auction to select one or more advertisements to present to a viewing user. The functionalities of the revenue scoring module 235, the quality scoring module 240, and the composite scoring module 245 are further described below in conjunction with FIG. 3.

The content selection module 250 selects one or more content items for presentation to a viewing user of the online system 140. Content items eligible for presentation to the viewing user are retrieved from the content store 210, from the ad request store 230, or from another source by the content selection module 250, which selects one or more of the content items for presentation to the viewing user. A content item eligible for presentation to the viewing user is associated with at least a threshold number of targeting criteria satisfied by user attributes associated with the viewing user or is a content item that is not associated with targeting criteria. In various embodiments, the content selection module 250 includes content items eligible for presentation to the viewing user in one or more content selection processes, which identify a set of content items for presentation to the viewing user. For example, the content selection module 250 determines measures of relevance of various content items to the viewing user based on user attributes associated with the viewing user by the online system 140 and based on the viewing user's affinity for different content items. Based on the measures of relevance, the content selection module 250 selects content items for presentation to the viewing user. As an additional example, the content selection module 250 selects content items having the highest measures of relevance or having at least a threshold measure of relevance for presentation to the viewing user. Alternatively, the content selection module 250 ranks content items based on their associated measures of relevance and selects content items having the highest positions in the ranking or having at least a threshold position in the ranking for presentation to the viewing user.

In various embodiments, the content selection module 250 selects one or more content items (e.g., advertisements) for presentation to the viewing user based on composite scores associated with one or more content items eligible to be presented to the viewing user. For example, the content selection module 250 may rank a content item based on its associated composite score among one or more additional content items (e.g., based on their associated composite scores or any other suitable value associated with each additional content item). In this example, the content selection module 250 may then select one or more content items associated with at least a threshold ranking for presentation to the viewing user. The content selection module 250 also may determine the order in which selected content items are presented (e.g., in a feed of content items). For example, the content selection module 250 orders advertisements and other content items in a newsfeed based on likelihoods of the viewing user interacting with various content items.

Content items selected for presentation to the viewing user may include advertisements or other content items associated with bid amounts. The content selection module 250 may use the bid amounts associated with content items when selecting content for presentation to the viewing user. For example, if the composite scores associated with one or more content items are expressed as bid amounts, the content selection module 250 may rank the content items based on their associated bid amounts (e.g., in an advertisement auction) and select one or more content items for presentation to the viewing user based on the ranking/bid amounts.

In some embodiments, the content selection module 250 ranks both content items associated with composite scores not expressed as bid amounts and content items associated with composite scores expressed as bid amounts (e.g., advertisements) in a unified ranking. Based on the unified ranking, the content selection module 250 selects content for presentation to the user. Selecting ad requests and other content items through a unified ranking is further described in U.S. patent application Ser. No. 13/545,266, filed on Jul. 10, 2012 (U.S. Publication No. US20140019261 A1, published on Jan. 16, 2014), which is hereby incorporated by reference in its entirety. The functionality of the content selection module 250 is further described below in conjunction with FIG. 3.

The web server 255 links the online system 140 via the network 120 to the one or more client devices 110, as well as to the third party system 130 and/or one or more third party systems. The web server 255 serves web pages, as well as other content, such as JAVA®, FLASH®, XML and so forth. The web server 255 may receive and route messages between the online system 140 and the client device 110, for example, instant messages, queued messages (e.g., email), text messages, short message service (SMS) messages, or messages sent using any other suitable messaging technique. A user may send a request to the web server 255 to upload information (e.g., images or videos) that are stored in the content store 210. Additionally, the web server 255 may provide application programming interface (API) functionality to send data directly to native client device operating systems, such as IOS®, ANDROID™, WEBOS® or BlackberryOS.

Determining a Composite Score Associated with a Content Item

FIG. 3 is a flow chart of a method for determining a composite score that includes revenue and quality components associated with a content item eligible to be presented to a viewing user of an online system according to one embodiment. In other embodiments, the method may include different and/or additional steps than those shown in FIG. 3. Additionally, steps of the method may be performed in a different order than the order described in conjunction with FIG. 3.

In some embodiments, the online system 140 receives 305 a plurality of user quality ratings associated with one or more content items presented to viewing users of the online system 140. The user quality ratings may include explicit ratings received from viewing users of the online system 140 for various content items previously presented to the viewing users (e.g., results of surveys administered to individual viewing users or opinions of multiple viewing users obtained via crowdsourced data) describing the quality of the content items according to the viewing users. For example, the online system 140 administers surveys that allow viewing users to rate individual content items based on their quality or to assess the relative quality of content items in a side-by-side comparison, and subsequently receives 305 the users' responses. A user quality rating may be expressed as a score associated with the content item on a numerical scale or as a relative rating. For example, the user quality rating for a content item may be expressed as a numerical score selected from a range of one to five, in which a score of five indicates that the content item is of the highest quality and a score of one indicates that the content item is of the lowest quality. As an additional example, the user quality rating for multiple content items may be expressed as a ranking in which higher quality content items are ranked higher than lower quality rankings or as a preference of one content item over another as a result of using bakeoff testing. In some embodiments, the online system may also receive 305 explicit quality ratings from professional content item raters.

The online system 140 may store 310 the plurality of user quality ratings associated with the one or more content items previously presented to the viewing users of the online system 140. Each of the user quality ratings may be stored 310 in association with a user profile associated with a viewing user that provided the rating (e.g., in the user profile store 205) and may include information associated with the content item that was rated. For example, the response to a survey communicated to a viewing user about the quality of a content item is stored 310 in association with the viewing user's user profile and information describing the content item (e.g., an identifier associated with the content item).

The user quality ratings additionally or alternatively may be stored 310 in conjunction with the content items for which the ratings were provided (e.g., in one or more tables in the content store 210). For example, if a female viewing user from the U.S. provides a user quality rating for a content item, the online system 140 may store the 310 user quality rating in an entry in a table describing female viewing users who provided user quality ratings for the content item and in an additional entry in a table describing viewing users from the U.S. who provided user quality ratings for the content item. In this example, the entries may include an identifier associated with the viewing user, a time the viewing user provided the rating, or any other suitable information associated with the user quality rating.

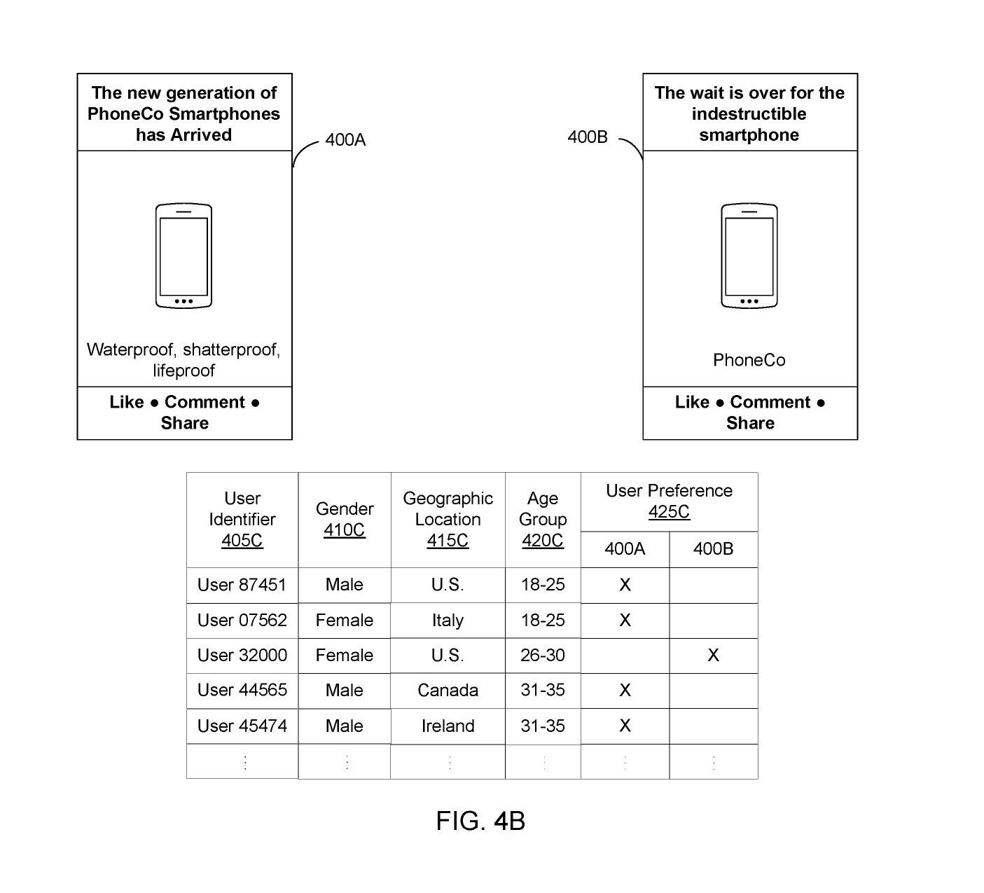

Alternatively, user quality ratings associated with each content item may be stored in a single table. For example, FIGS. 4A and 4B depict examples of user quality ratings for one or more content items 400A-B in which the user quality ratings 425A-C for the content items 400A-B are stored 310 in a table that includes on one or more user attributes associated with the viewing users who provided the ratings. Referring first to FIG. 4A, the user quality ratings 425A-B for two different content items 400A-B are stored 310 in different tables, in which each table is associated with a content item 400A-B and the user quality ratings 425A-B for the content items 400A-B are expressed as numerical values selected from a range of one to five. Each table may be updated periodically or as the user quality ratings are received 305 by the online system 140.

Each table includes a user identifier 405A that uniquely identifies each viewing user who provided a rating and attributes associated with each viewing user that describe the user's gender 410A-B, geographic location 415A-B, and age group 420A-B. In some embodiments, the tables may include additional types of user attributes and may indicate an absence of available user attribute information for a particular user. Furthermore, each table may include additional types of information describing the data included within them (e.g., total number of viewing users whose user quality ratings are included in a table, average user rating by user attribute, etc.).

As shown in FIG. 4B, the user quality ratings for the content items 400A-B additionally or alternatively may be expressed as relative ratings in a single table. The table includes the preferences 425C of viewing users for one of the content items 400A-B over the other (e.g., indicated by an “X”). The users' preferences 425C may be obtained from surveys or other types of tests administered to the users that allow the two content items 400A-B to be compared (e.g., via a bakeoff test). In some embodiments, the table may include user preferences 425C for additional content items as well. For example, the content items 400A-B may be included among additional content items presented to viewing users. The table may be modified to include an additional column for each additional content item, such that the users' preferences 425C for these additional content items also may be included in the table. Similar to FIG. 4A, the table includes a user identifier 405C that uniquely identifies each viewing user who provided a rating and attributes associated with each viewing user that describe the user's gender 410C, geographic location 415C, and age group 420C. Also similar to FIG. 4A, the table may include additional types of information describing the data included within them (e.g., total number of ratings), as well as additional types of user attributes and indications of unavailable user attribute information. Furthermore, the table also may be updated periodically or as the user quality ratings are received 305 by the online system 140.

Referring back to FIG. 3, the online system 140 identifies 315 an opportunity to present a content item to a prospective viewing user of the online system 140 who is associated with one or more user attributes. For example, the online system 140 receives a request to present a feed of content items (e.g., a newsfeed) to the prospective viewing user via a client device 110 associated with the viewing user. Examples of user attributes include biographic, demographic, and other types of descriptive information associated with the prospective viewing user, such as work experience, educational history, gender, hobbies, preferences or interests, geographic region (e.g., hometown or workplace), connections between the prospective viewing user and other users, actions performed by the prospective viewing user, etc. The user attributes may be stored in association with a user profile associated with the prospective viewing user maintained by the online system 140 in the user profile store 205.

The online system 140 may identify 320 one or more content items eligible for presentation to the prospective viewing user. In various embodiments, content items may be associated with targeting criteria identifying user attributes of online system users who are eligible to be presented with the content items. In such embodiments, content items are only eligible for presentation to the prospective viewing user if the content items are associated with targeting criteria that match those of the prospective viewing user. For example, if a content item is associated with targeting criteria identifying one or more user attributes of users who are eligible to be presented with the content item, the online system 140 determines that the prospective viewing user is eligible to be presented with the content item if the prospective viewing user is associated with at least a threshold number of the user attributes.

The revenue scoring module 235 determines 325 a revenue score associated with a content item eligible for presentation to the prospective viewing user. The revenue score is determined 325 based at least in part on a bid amount or other value an advertiser associated with the content item is willing to pay for an impression of the content item by the prospective viewing user or for receiving an interaction with the content item by the prospective viewing user (e.g., a click on the content item by the prospective viewing user, a comment on the content item by the prospective viewing user, etc.). In some embodiments, the revenue score may be specific to the prospective viewing user. For example, if the prospective viewing user has made several purchases in the past after clicking through an advertisement associated with an advertiser, the bid amount and thus, the revenue score associated with a new advertisement associated with the advertiser is higher for the prospective viewing user than it would be if the prospective viewing user had not made any purchases after clicking through the advertisement associated with the advertiser.

The online system 140 retrieves 330 the plurality of user quality ratings associated with content items previously presented to viewing users of the online system 140. The user quality ratings may be retrieved 330 from the user profile store 205 and/or from the content store 210, e.g., the ratings having been received 305 and stored 310 as described above. The online system 140 also may identify one or more of the plurality of user quality ratings determined by one or more of the viewing users associated with one or more user attributes having at least a threshold measure of similarity to the user attributes associated with the prospective viewing user. For example, when the online system 140 retrieves 330 the user quality ratings from the user profile store 205, the online system 140 also identifies user quality ratings provided by viewing users belonging to the same age group and of the same gender as the prospective viewing user, who also have at least one interest in common with the prospective viewing user. As an additional example, in embodiments in which the user quality ratings are stored 310 in one or more tables in the content store 210, when the online system 140 retrieves 330 the user quality ratings, the online system 140 identifies tables or entries within the tables that correspond to user quality ratings provided by users associated with one or more user attributes having at least a threshold measure of similarity to the user attributes associated with the prospective viewing user. In some embodiments, the online system 140 retrieves 330 only user quality ratings from the user profile store 205 and/or the content store 210 that were provided by viewing users associated with user attributes having at least a threshold measure of similarity to the user attributes associated with the viewing user.

The quality scoring module 240 predicts 335 a quality score associated with the content item eligible to be presented to the prospective viewing user. The quality score is indicative of the quality of the content item to the prospective viewing user and is based on a predicted user quality rating associated with the content item for the prospective viewing user. For example, the quality score associated with an advertisement may be predicted 335 based on a predicted user quality rating associated with the advertisement for the prospective viewing user. In this example, the user quality rating is selected from a range of one to five, in which a rating of five indicates that the viewing user will likely rate the advertisement a high-quality content item and a rating of one indicates that the viewing user will likely rate the advertisement a low-quality content item.

The quality score may indicate a likelihood that the prospective viewing user will have an interest in a content item and/or a likelihood that the prospective viewing user will perform one or more types of interactions with the content item. For example, the quality scoring module 240 predicts 335 the quality score associated with a content item based on a sum of a viewing user's predicted user quality rating associated with the content item and predicted likelihoods that the viewing user will perform one or more types of interactions with the content item (e.g., indicate a preference for the content item, click on the content item, share the content item, etc.). In various embodiments, the likelihoods that the prospective viewing user will perform different types of interactions with the content item may be associated with different weights. For example, if an advertiser has a goal of increasing the number of viewing users who share an advertisement by 50% and a goal of increasing the number of viewing users who express a preference for the advertisement by 25%, when determining the quality score associated with the advertisement, the quality scoring module 240 may associate a greater weight with a probability that the prospective viewing user will share the advertisement than with a probability that the prospective viewing user will express a preference for the advertisement. In this example, the quality scoring module 240 may weight the probability that the prospective viewing user will share the advertisement twice as much as the probability that the prospective viewing user will express a preference for the advertisement by associating the former with a weight of 1.0 and the latter with a weight of 0.5.

The quality score is predicted 335 by the quality scoring module 240 based at least in part on one or more of the plurality of user quality ratings provided by one or more viewing users associated with one or more user attributes having at least a threshold measure of similarity to one or more user attributes associated with the prospective viewing user. In some embodiments, the quality scoring module 240 may predict the user quality rating associated with a content item for a viewing user using a machine-learned model. The machine-learned model may be trained using one or more of the plurality of user quality ratings provided by one or more viewing users associated with one or more user attributes having at least a threshold measure of similarity to one or more user attributes associated with the prospective viewing user. The trained model may then predict the user quality rating associated with a content item for the prospective viewing user. For example, the machine-learned model predicts the prospective viewing user's user quality rating associated with a content item based on results received from viewing users surveyed about the content item, in which the viewing users are associated with demographic information having at least a threshold measure of similarity to that associated with the viewing user. In this example, the machine-learned model may predict the viewing user's user quality rating as an average of the survey results received from the viewing users. As an additional example, the machine-learned model uses crowdsourced user quality ratings received from viewing users who tend to express a preference for content items at about the same rate as the prospective viewing user and have at least a threshold percentage of connections to additional users of the online system 140 in common with the prospective viewing user and uses the user quality ratings of these viewing users for advertisements to predict the prospective viewing user's user quality rating for an advertisement.

In various embodiments, each individual rating is used to train the machine-learned model. For example, each individual rating received 305 from viewing users is an instance in a set of training data that is used to train the machine-learned model. In embodiments in which the online system 140 also receives 305 explicit quality ratings from professional content item raters, these ratings may be used to train the machine-learned model as well. For example, the set of training data used to train the machine-learned model in the previous example may include instances that each correspond to a quality rating received from a professional content item rater. In some embodiments, multiple individual ratings may be compiled into a single instance included in a set of training data that is used to train the machine-learned model. For example, individual ratings collected over the course of a day or received from users associated with a particular demographic group are averaged; this average rating is then used to train the machine-learned model.

In some embodiments, the machine-learned model may associate different weights with user quality ratings associated with various content items received 305 from viewing users of the online system 140 based on user attributes associated with the viewing users. For example, the machine-learned model may predict the user quality rating for the content item by the prospective viewing user by weighting user quality ratings received from viewing users who have more user attributes (e.g., age group, gender, geographic location, click-through rates, etc.) in common with the prospective viewing user more heavily than user quality ratings received from users who have fewer user attributes in common with the prospective viewing user. As an additional example, since purchasing a product or subscribing to a service after clicking through an advertisement for the product or service is a reliable indicator of the quality of the advertisement, the machine-learned model may associate weights with user quality ratings received from viewing users that are proportional to the rates at which the viewing users purchased products or subscribed to services in conjunction with clicking on advertisements.

The machine-learned model also may associate different weights with the user quality ratings received 305 from viewing users of the online system 140 based on content item features associated with the content items rated by the viewing users. For example, the machine-learned model may predict the user quality rating associated with an advertisement for lace dresses by the prospective viewing user by associating weights with user quality ratings received 305 from viewing users of the online system 140 for various advertisements based on the advertisements' measure of similarity to the advertisement for lace dresses. In this example, user quality ratings for the same advertisement are weighted more heavily than user quality ratings for advertisements for lace dresses in general, which are weighted more heavily than user quality ratings for non-lace dresses, which are weighted more heavily than user quality ratings for non-dress clothing items, etc.

The composite scoring module 245 determines 340 a composite score associated with the content item based at least in part on the revenue score and the quality score. For example, the composite scoring module 245 determines 340 the composite score associated with an advertisement as a sum of its quality score and its revenue score. In various embodiments, the quality score and revenue score associated with the content item may contribute unequally to the composite score. For example, the composite scoring module 245 may associate different weights with the quality score and the revenue score and determine 340 the composite score based on the weights. In some embodiments, the composite score is expressed as a bid amount used in a content selection process to select one or more content items for presentation to the prospective viewing user. For example, if the content item is an advertisement, the composite score is a bid amount that is used in an advertisement auction to select one or more advertisements to present to the prospective viewing user.

The content selection module 250 may select 345 one or more content items (e.g., advertisements) for presentation to the prospective viewing user. The content items may be selected 345 by the content selection module 250 based on composite scores associated with one or more content items eligible to be presented to the viewing user. For example, the content selection module 250 may rank a content item based on its associated composite score among one or more additional content items (e.g., based on their associated composite scores or based on any other suitable value associated with each additional content item). In this example, the content selection module 250 may select 345 one or more content items associated with at least a threshold ranking or composite score for presentation to the prospective viewing user. In embodiments in which the composite scores associated with one or more content items are expressed as bid amounts, the content selection module 250 may rank the content items based on their associated bid amounts and select 345 one or more content items for presentation to the viewing user based on their associated ranking/bid amounts (e.g., in an advertisement auction).

The online system 140 may present 350 the one or more content items selected 345 by the content selection module 250 to the prospective viewing user. For example, the content item may be presented 350 via a display area of a client device 110 associated with the prospective viewing user. In some embodiments, the one or more content items may be included in a newsfeed or other type of display unit that is presented 350 to the prospective viewing user. For example, if the one or more content items are advertisements, the content items may be presented 350 in a scrollable advertisement unit.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
identifying an opportunity to present a content item to a prospective viewing user of an online system, the prospective viewing user associated with one or more user attributes;
determining a revenue score associated with the content item based at least in part on a value that an advertiser is willing to pay in exchange for each of a set of interactions with the content item received from the prospective viewing user;
retrieving a plurality of user quality ratings associated with one or more content items previously presented to a plurality of viewing users of the online system, each of the plurality of user quality ratings describing a quality of each of the one or more content items determined by a viewing user of the plurality of viewing users;
predicting a quality score indicative of a quality of the content item to the prospective viewing user, the quality score based at least in part on one or more of the plurality of user quality ratings determined by one or more of the plurality of viewing users associated with one or more additional user attributes having at least a threshold measure of similarity to the one or more user attributes associated with the prospective viewing user; and
determining a composite score associated with the content item based at least in part on the revenue score and the quality score.

2. The method of claim 1, wherein each of the one or more content items previously presented to the plurality of viewing users of the online system is associated with one or more content item features having at least a threshold measure of similarity to one or more additional content item features associated with the content item.

3. The method of claim 1, wherein one or more of the plurality of user quality ratings associated with the one or more content items comprise one or more results of a survey communicated to the plurality of viewing users.

4. The method of claim 1, wherein one or more of the plurality of user quality ratings associated with the one or more content items comprise crowdsourced user quality ratings.

5. The method of claim 1, wherein predicting the quality score indicative of a quality of the content item to the prospective viewing user comprises:
associating a weight with one or more of the plurality of user quality ratings associated with the one or more content items; and
predicting the user quality rating of the prospective viewing user indicating the quality of the content item based at least in part on the weight associated with one or more of the plurality of user quality ratings.

6. The method of claim 5, wherein the weight associated with one or more of the plurality of user quality ratings is based at least in part on one or more selected from a group consisting of: a measure of similarity between the one or more user attributes associated with the prospective viewing user and the one or more additional user attributes associated with the one or more of the plurality of viewing users, a measure of similarity between one or more content item features associated with each of the one or more content items previously presented to the plurality of viewing users of the online system and one or more additional content item features associated with the content item, and any combination thereof.

7. The method of claim 1, wherein the quality score associated with the content item is further based at least in part on a predicted likelihood that the prospective viewing user will perform each of the set of interactions with the content item.

8. The method of claim 7, wherein the predicted likelihood that the prospective viewing user will perform each of the set of interactions with the content item is associated with a weight.

9. The method of claim 1, wherein the set of interactions with the content item is selected from a group consisting of: clicking on the content item, expressing a preference for the content item, sharing the content item with additional users of the online system, commenting on the content item, attending an event associated with the content item, joining a group associated with the content item, subscribing to a service associated with the content item, purchasing a product associated with the content item, and any combination thereof.

10. The method of claim 1, wherein one or more of the plurality of user quality ratings associated with the one or more content items comprise relative user quality ratings associated with the one or more content items.

11. The method of claim 1, further comprising:
training a machine-learned model to predict the quality score indicative of the quality of the content item to the prospective viewing user based at least in part on the plurality of user quality ratings.

12. The method of claim 11, wherein the quality score indicative of the quality of the content item to the prospective viewing user is predicted using the machine-learned model.

13. The method of claim 1, further comprising:
receiving the plurality of user quality ratings associated with the one or more content items previously presented to the plurality of viewing users of the online system; and
storing the plurality of user quality ratings associated with the one or more content items.

14. The method of claim 1, further comprising:
ranking the content item among one or more additional content items based at least in part on the composite score associated with the content item; and
selecting a set of content items associated with at least a threshold ranking or at least a threshold composite score for presentation to the prospective viewing user.

15. The method of claim 14, further comprising:
presenting the set of content items associated with at least the threshold ranking or at least the threshold composite score to the prospective viewing user.

16. A computer program product comprising a computer readable storage medium having instructions encoded thereon that, when executed by a processor, cause the processor to:
identify an opportunity to present a content item to a prospective viewing user of an online system, the prospective viewing user associated with one or more user attributes;
determine a revenue score associated with the content item based at least in part on a value that an advertiser is willing to pay in exchange for each of a set of interactions with the content item received from the prospective viewing user;
retrieve a plurality of user quality ratings associated with one or more content items previously presented to a plurality of viewing users of the online system, each of the plurality of user quality ratings describing a quality of each of the one or more content items determined by a viewing user of the plurality of viewing users;
predict a quality score indicative of a quality of the content item to the prospective viewing user, the quality score based at least in part on one or more of the plurality of user quality ratings determined by one or more of the plurality of viewing users associated with one or more additional user attributes having at least a threshold measure of similarity to the one or more user attributes associated with the prospective viewing user; and
determine a composite score associated with the content item based at least in part on the revenue score and the quality score.

17. The computer program product of claim 16, wherein each of the one or more content items previously presented to the plurality of viewing users of the online system is associated with one or more content item features having at least a threshold measure of similarity to one or more additional content item features associated with the content item.

18. The computer program product of claim 16, wherein one or more of the plurality of user quality ratings associated with the one or more content items comprise one or more results of a survey communicated to the plurality of viewing users.

19. The computer program product of claim 16, wherein one or more of the plurality of user quality ratings associated with the one or more content items comprise crowdsourced user quality ratings.

20. The computer program product of claim 16, wherein predict the quality score indicative of a quality of the content item to the prospective viewing user comprises:
associate a weight with one or more of the plurality of user quality ratings associated with the one or more content items; and
predict the user quality rating of the prospective viewing user indicating the quality of the content item based at least in part on the weight associated with one or more of the plurality of user quality ratings.

21. The computer program product of claim 20, wherein the weight associated with one or more of the plurality of user quality ratings is based at least in part on one or more selected from a group consisting of: a measure of similarity between the one or more user attributes associated with the prospective viewing user and the one or more additional user attributes associated with the one or more of the plurality of viewing users, a measure of similarity between one or more content item features associated with each of the one or more content items previously presented to the plurality of viewing users of the online system and one or more additional content item features associated with the content item, and any combination thereof.

22. The computer program product of claim 16, wherein the quality score associated with the content item is further based at least in part on a predicted likelihood that the prospective viewing user will perform each of the set of interactions with the content item.

23. The computer program product of claim 22, wherein the predicted likelihood that the prospective viewing user will perform each of the set of interactions with the content item is associated with a weight.

24. The computer program product of claim 16, wherein the set of interactions with the content item is selected from a group consisting of: clicking on the content item, expressing a preference for the content item, sharing the content item with additional users of the online system, commenting on the content item, attending an event associated with the content item, joining a group associated with the content item, subscribing to a service associated with the content item, purchasing a product associated with the content item, and any combination thereof.

25. The computer program product of claim 16, wherein one or more of the plurality of user quality ratings associated with the one or more content items comprise relative user quality ratings associated with the one or more content items.

26. The computer program product of claim 16, wherein the computer readable storage medium further has instructions encoded thereon that, when executed by the processor, cause the processor to:
train a machine-learned model to predict the quality score indicative of a quality of the content item to the prospective viewing user based at least in part on the plurality of user quality ratings.

27. The computer program product of claim 26, wherein the quality score indicative of the quality of the content item to the prospective viewing user is predicted using the machine-learned model.

28. The computer program product of claim 16, wherein the computer readable storage medium further has instructions encoded thereon that, when executed by the processor, cause the processor to:
receive the plurality of user quality ratings associated with the one or more content items previously presented to the plurality of viewing users of the online system; and
store the plurality of user quality ratings associated with the one or more content items.

29. The computer program product of claim 16, wherein the computer readable storage medium further has instructions encoded thereon that, when executed by the processor, cause the processor to:
rank the content item among one or more additional content items based at least in part on the composite score associated with the content item; and
select a set of content items associated with at least a threshold ranking or at least a threshold composite score for presentation to the prospective viewing user.

30. The computer program product of claim 29, wherein the computer readable storage medium further has instructions encoded thereon that, when executed by the processor, cause the processor to:
present the set of content items associated with at least the threshold ranking or at least the threshold composite score to the prospective viewing user.

31. A method comprising:
identifying an opportunity to present a content item to a prospective viewing user of an online system, the prospective viewing user associated with one or more user attributes;
predicting a quality score indicative of a quality of the content item to the prospective viewing user based at least in part on a plurality of user quality ratings associated with one or more content items previously presented to a plurality of viewing users of the online system, each of the plurality of viewing users associated with one or more additional user attributes having at least a threshold measure of similarity to the one or more user attributes associated with the prospective viewing user, each of the plurality of user quality ratings describing a quality of each of the one or more content items determined by a viewing user of the plurality of viewing users;
determining a composite score associated with the content item based at least in part on a value that an advertiser is willing to pay in exchange for each of a set of interactions with the content item received from the prospective viewing user and the quality score;
selecting a set of content items for presentation to the prospective viewing user based at least in part on the composite score associated with the content item; and
presenting the set of content items to the prospective viewing user.
